(19) United States
(12) Patent Application Publication
(10) Pub. No.: US 2024/0155179 A1
(43) Pub. Date: May 9, 2024

(54) SYNCHRONIZED MEDIA EXPERIENCE SYSTEM THROUGH SIMILAR OR DISSIMILAR END-USER DEVICES

(71) Applicants: Darshan Sedani, Cerritos, CA (US); Teodros Gessesse, Leesburg, VA (US); Devang Ajmera, Gujarat (IN); Joy Shah, Gujarat (IN); Jason LaVardera, Ridgefield, CT (US); Joshua LaVardera, Ridgefield, CT (US); Thomas LaVardera, Ridgefield, CT (US); Mike Sturges, Ridgefield, CT (US); Rajkumar Ramakrishnan, Gujarat (IN); Priyanka Gajjar, Gujarat (IN); Vaidehi Smart, Gujarat (IN)

(72) Inventors: Darshan Sedani, Cerritos, CA (US); Teodros Gessesse, Leesburg, VA (US); Devang Ajmera, Gujarat (IN); Joy Shah, Gujarat (IN); Jason LaVardera, Ridgefield, CT (US); Joshua LaVardera, Ridgefield, CT (US); Thomas LaVardera, Ridgefield, CT (US); Mike Sturges, Ridgefield, CT (US); Rajkumar Ramakrishnan, Gujarat (IN); Priyanka Gajjar, Gujarat (IN); Vaidehi Smart, Gujarat (IN)

(21) Appl. No.: 17/980,278

(22) Filed: Nov. 3, 2022

Related U.S. Application Data
(63) Continuation of application No. 17/980,148, filed on Nov. 3, 2022.

(51) Int. Cl. H04N 21/43; H04N 21/478

(52) U.S. Cl. CPC H04N 21/43076; H04N 21/43079; H04N 21/478

(57) ABSTRACT

A system comprising computer hardware, computer software, various client end-user devices, and methodology for co-viewing of media and conducting synchronization of viewing by two or more system users through over-the-top (OTT) media devices, mobile devices, tablets devices or Web platform. Said system enables sychronization of the content viewing experience between a first logged-in user of the system who is authorized to perform synchronization, and one or a plurality of other users who are logged into the system, wherein one user serves as a guide and the other user or users are followers of the viewed content media.

### CROSS-REFERENCE TO RELATED APPLICATIONS

This application is related to and claims priority to U.S. Application entitled OTT platform for Real Estate, application Ser. No. 17/980,148 (Attorney Docket No. 2685.1001); filed Nov. 3, 2022; in the U.S. Patent and Trademark Office, the disclosure of which is incorporated herein in its entirety

This application includes material that is subject to copyright protection.

### FIELD

This invention is in the field of devices, systems and methods for sharing media experiences. The field includes over-the-top (OTT) viewing devices used in conjunction with conventional television, as well as devices such as laptop computers, desktop computers, mobile phones and tablets, and software designed to run on such platforms, including collaborative viewing and collaborative work software.

### DESCRIPTION OF RELATED ART

When we watch television, we often have someone else in our household watching with us: a spouse, a child, a roommate, or a family guest. That behavior is called ‘co-viewing,’ and it has been a topic of intense social research for as long as television has been around.

With the increase of OTT viewing of media through a wide range of OTT devices and systems, and with many people subscribed to different platforms, co-viewing has become a social phenomenon where groups of people will watch a show together, even if they are not physically in the same place. Individuals also use social media (Facebook, Twitter, WhatsApp, Snapchat, Instagram) to discuss media shows they have viewed from their individual vantage points.

Co-viewing has been a topic of commercial interest as well ever since it was discovered that joint media attention could improve learning, engage memory and, by extension, stimulate brand recall. Today, co-viewing is not limited to traditional television viewing-what we refer to in the industry as linear TV. With the emergence of digital technologies and increased content streaming over the internet, co-viewing has become vital for media companies to understand consumers' behavioral patterns across different platforms.

While co-viewing trends on tablets and smartphones have been studied, co-viewing activity using OTT devices (set-top devices like Roku and Apple TV, Smart TVs, and game consoles) has received limited attention due to a lack of accurate measurement solutions. However, with programming content typically displayed on a regular-size television screen and in a familiar household setting—the hallmarks of traditional co-viewing activity-OTT devices are probably the digital platform group that should invite the most immediate scrutiny.

With the technology get advance day by day, not all people are used to or are aware of how to find or use the latest technology. A synchronization feature enabling co-viewing would be useful in this scenario, enabling one individual to show another a range of content, processes, and access methods for co-viewing.

### SUMMARY

The Synchronized Media Experience System (SMES) is a robust system and methodology for co-viewing activity on OTT devices, mobile devices, tablets devices and web platform.

In one embodiment described hereunder, this combined system and methodology is added to an OTT Platform for Real Estate serving the real estate industry. Using the SMES, a Realtor can ask a potential buyer to enable the Sync feature button on the devices that they are watching, be it their mobile, tablet or TV. Once the sync feature button is enabled, the Realtor does the same by login into the system using the same account. The important thing to note here is that the Realtor can be using a similar or different device as the buyer.

With this robust synchronization feature, Realtors can show properties virtually to their potential buyers who might be sitting in a different location. Using the SMES, both Realtor and buyer can navigate through the property together. Whatever Realtors wants to show to their buyers, both see the same thing even though they both are on different devices. This sync feature or co-viewing functionality is totally different from simple mirroring, in that it allows interactivity between the counterparties. The sync functionality allows the Realtor to take control of showing the property. It's a visa-versa. Buyer too can navigate through the property and Realtor will see the same. Anyone of them can disconnect the Sync functionality just by disabling the Sync button.

In another embodiment, the SMES may be used by members of the same household watching television at the same time but not necessarily in the same room or same place.

In another embodiment, the SMES may be used to provide guided tours of facilities such as museums, gardens, and other venues where the interaction between the underlying context and the user of the system is primarily a viewing experience.

### BRIEF DESCRIPTION OF THE DRAWINGS

FIG. 1 is a diagram illustrating the major working processes and their data flows in relationship to each other, including the synchronization of the viewing experience of one user with another.

FIG. 2 is a diagram illustrating multi-party synchronization, where one party may serve as a guide to multiple other parties with a shared content viewing experience among all the parties.

### DETAILED DESCRIPTION

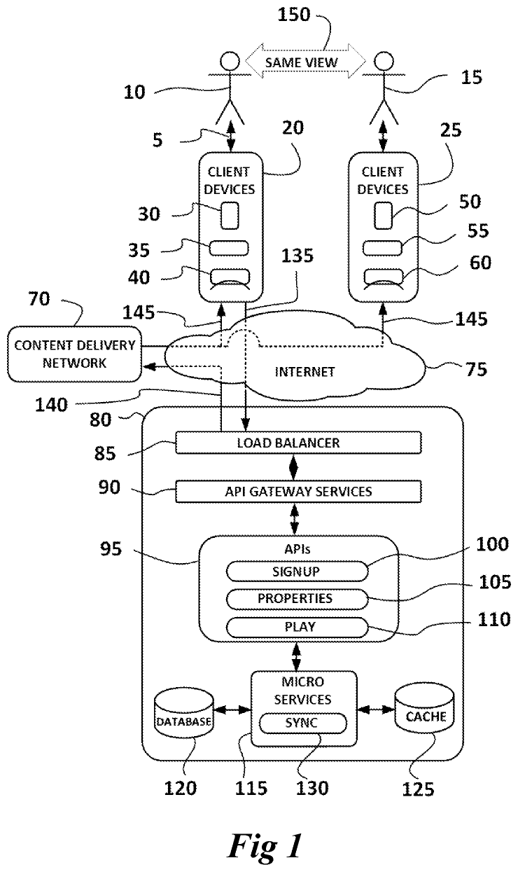

Context. The SMES is a co-viewing synchronization system and set of methods applicable in the context of OTT systems, and other situations where multiple parties may benefit from having similar views of physical or virtual content. A background system is typically required as a contextual component of the overall system, comprising a range of functionalities. Referring to FIG. 1, these system contextual components and functionalities are hardware and software which control user participation, as well as synchronization. Data pathways are illustrated as arrows 5, typical of multiple places in the Figure. A software system 80 is contained in suitable commercial server hardware, said software system comprising, at a minimum, a network load balancer 85 to handle inbound and outbound data traffic, a set of application programming interface (API) gateway services 90 to route traffic to appropriate APIs, a set of APIs comprising interfaces to a user sign-up subsystem API 100, a properties database API 105 storing properties of individual users and other aspects of the system, and a play system API 110 through which as shared viewing experience may be triggered and managed. These APIs access corresponding services run as micro-services 115, especially including the synchronization micro-service 130. Said micro-services are supported by a database of characteristics 120, and an in-RAM operational cache 125 used to maintain a high system throughput.

General Process Flow. Any user of the SMES system, 10 or 15, may sign up, or once signed up, log into the system 80, through any client devices 20 or 25, from among mobile devices 30 or 50, laptop or tablet devices 35 or 55, or regular computers 40 or 60, accessing the microservices 115 of the system 80 through the APIs 95. Such processes flow from the end user client devices through the Internet 75.

Synchronization of viewing experience. Referring again to FIG. 1, synchronization and co-viewing of content is conducted through the following steps. Presume for this description that both users 10 and 15 are logged into the system, and each user has access to the system and is viewing the system through a selected end-user client device from within choices comprising either 20 or 25. First user 10, connected to the so-called “back end” portion of the system 80 through a client device and through the Internet 75 sends a signal 135 to the sync function 130, specifying the other user 15 as represented by the other user's client device, and referencing the first user's viewed content obtained 145 from a content delivery network 70. Then the sync micro-service sends a signal 140 to the same content delivery network 70 sending 148 the same viewing content to the second user 15. The synchronization is triggered by an on/off sync button in the user interface of user 1, and may be discontinued by means of a similar button in the user interface of the second user. When synchronized, both users have the same viewing experience 150.

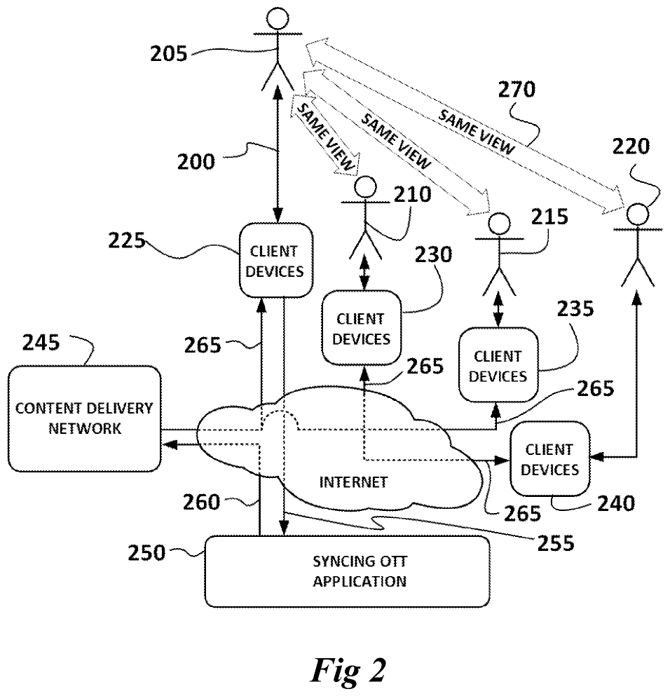

Referring to FIG. 2, the same process of synchronization may be used to synchronize multiple users to the viewing experience of a first user. The overall system in this case comprises multiple users 205, 210, 215, and 220, each accessing the system through corresponding client end-user devices 225 for the first user, 230 for the second user, 235 for the third user, and 240 for the fourth user, a back-end syncing OTT application 250, and a content delivery network 245, the latter possibly external and managed commercially. Although not shown, the system can support an arbitrary number of additional users.

Presuming that each user is suitably logged into the back-end system 250, the syncing function occurs by the first user 205 sending a syncing signal 255 to the back-end system, which identifies each logged-in user, and the sync function in turn sends a signal 260 to the content delivery network, which in turn sends 265 the viewable content to each of the users 205, 210, 215, and 220, resulting in the same viewing experience 270 for all synced users, typical of four users as illustrated in the case of FIG. 2, but extensible to more users (not shown). Each user can selectively turn off or on the sync function from their own vantage point, joining or leaving the co-viewing experience as led by the first user.

Embodiments. In one embodiment, the system may be used in the context of real estate sales. In this case, a Realtor serves as the first user, synchronizing a viewing experience through the system to a potential buyer of real estate as a second user of the system. The Realtor is then able to provide a guided tour of an instance of real estate or real property, through various kinds of media which serve as illustrative content. Such content can be any media comprising written text, static graphics, animations, video, three-dimensional virtual-reality content, and augmented-reality content. The prospective buyer can interact with the Realtor in real-time to pose questions and obtain a personalized understanding of the property being viewed, enhancing the probability that the Realtor will likely be able to make the sale. Realtors may also use the system to guide prospective buyers through a tour of a mapping system to enlighten prospective buyers about the neighborhood of the property in question.

In another embodiment, the system may be used in the context of exhibitions comprising museums or botanical gardens, or other permanent venues or temporary events where a guided walk-through is desirable. In such cases, pre-planned narratives may be prepared for use by the first (guide) user, and co-viewed or heard by the other co-users of the system.

In yet another embodiment, the system may be used in the context of news services or societal emergency services, where a first user such as a reporter or emergency services worker is on scene in a societally important context or event, and can sync other users and show them the activity, events, or conditions of the location in an interactive way.

In yet another embodiment, the system may be used in the context of telemedicine, where medical personnel may sync a patient or an assistant to a patient and enable the patient or assistant to take control of the guidance and show the medical personnel the patient's condition.

1. A centralized system, comprising:
a computer hardware including a computer software program or a plurality of related software programs stored therein, the computer hardware communicating with one or a plurality of remote end-user computer devices, and
wherein the one or the plurality of remote end-user computer devices run software interoperating with a centralized software, for collaborative viewing of content between two or more users where a shared viewing experience is invoked through one or multiple synchronizations to thereby allow control over interactivity and navigation of the content between users using similar or dissimilar end-user devices.

2. A method of collaboration between at least two users of media viewing software system, comprising:
synchronizing a viewing experience of each user with another user such that each user is participating in the viewing experience and taking actions on the media viewing software system through similar or different access devices; and
the method further comprising:
allowing one user synchronized with another user to direct the media viewing software system to connect a centralized computer software with a remote viewing software; and
allowing the one user synchronized with the other user to lead the synchronized viewing experience and the other user to follow the synchronized viewing experience.

3. The method of claim 2, wherein the collaboration between at least two users of the synchronized viewing experience through the media viewing software system may involves multiple other users, where a first user synchronizes with one or more other users using the synchronized viewing experience system, the first user leads the one or more users through a viewing and participation experience, whereby all other users are viewing identical or similar content and having similar or identical personal experiences in relation to content presented.

4. The method of claim 3, wherein the collaboration between at least two users of the synchronized viewing experience through the media viewing software system allows communication between any two or multiple of users as follows:
one user providing audio narration to other users accompanying the synchronized viewing experience; and with
any user speaking with any other user using audio; and
any user sending written chat or text communications to any other user.

5. The method of claim 3, wherein a first user conducts a live guided tour through a synchronized visual experience with one or more other users, such that the first user is proximate or remote from the other users with other users receiving audio and textual information supplementing the synchronized visual experience.

6. The centralized system of claim 1, wherein one user is commanding a shared content of the centralized system, delivering to all participating viewing users content from an external content delivery network.

7. The centralized system of claim 1, wherein end-user client devices of participating users are identified and classified against a database of possible types of end-user client devices, and the centralized system adapts to end-user visual and participatory experiences in terms of characteristics comprising visual layout, communications channels, control buttons, and user interface features specific to the end-user client devices identified.
